(19) United States
(12) Patent Application Publication
(10) Pub. No.: US 2006/0267979 A1
(43) Pub. Date: Nov. 30, 2006

(54) Apparatus and method for processing three-dimensional images

(75) Inventor: Fou-Ming Liou, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/411,962

(22) Filed: Apr. 27, 2006

(30) Foreign Application Priority Data
May 25, 2005 (TW) 94117118

(51) Int. Cl. G06T 17/00

(52) U.S. Cl. 345/420

(57) ABSTRACT

An apparatus for processing three-dimensional (3D) images has a 3D graphics engine, a data collector and a 3D monitor generator. The 3D graphics engine receives 3D environment information from a software application and generates a 3D main image according to the 3D environment information. The data collector acquires the 3D environment information between the software application and the 3D graphics engine. The 3D monitor generator is connected to the data collector and generates an assist image according to the acquired 3D environment information.

### RELATED APPLICATIONS

The present application is based on, and claims priority from, Taiwan Application Serial Number 94117118, filed May 25, 2005, the disclosure of which is hereby incorporated by reference herein in its entirety.

### BACKGROUND

1. Field of Invention

The present invention relates to an apparatus and method for processing image data. More particularly, the present invention relates to an apparatus and method for processing three-dimensional (3D) images.

2. Description of Related Art

As information technology progresses, the efficiencies of processors and graphics engines have become better and better. Thus, software applications that employ a 3D graphics engine to display images are more popular today. For example, novel game software usually displays 3D images for providing the consumers varied and realistic scenes.

FIG. 1 is a schematic diagram of a traditional 3D image processing apparatus. This traditional 3D image processing apparatus 100 is adapted to, for example, game software. In FIG. 1, a 3D graphics engine 102 generates a 3D image to a display 101 according to a 3D environment information from a game software 104.

When playing the game software, the player is enabled to watch a main image at a single predetermined visual angle, 45° for example, or at a visual angle according to the first person. Although some game software can provide 3D images at two or more visual angles, the player is still limited to watch the main image at a single visual angle at one time.

Alternatively, some game software provides a sub-image window within the main image, which is at a different visual angle than the main image. For example, some game software provides a main image which displays a particular region at a visual angle of 45° and a sub-image window which displays a top view of a global region. However, what the sub-image window displays may be concealed by other players or non-player characters (NPC).

The traditional software application often provides an image at a limited vision or visual angle, usually causing the user of the software application to make wrong decisions or actions. If more information is provided besides that image, which has been provided by traditional software applications, the user can have more basis to determine what to do.

### SUMMARY

It is therefore an aspect of the present invention to provide an apparatus for processing three-dimensional (3D) images. The apparatus can generate an assist image and users according to the assist image for having additional information.

According to a preferred embodiment of the invention, an apparatus for processing three-dimensional (3D) images has a 3D graphics engine, a data collector and a 3D monitor generator. The 3D graphics engine receives 3D environment information from a software application and generate a 3D main image according to the 3D environment information. The data collector such as 3D monitor filter acquires the 3D environment information between the software application and the 3D graphics engine. The 3D monitor generator is connected to the data collector and generates an assist image according to the acquired 3D environment information.

It is another aspect of the present invention to provide a method for processing three-dimensional (3D) images. The method can provide more information such that users can have more basis to determine what to do, and thus decisions or actions taken by the users can be more correct.

According to another preferred embodiment of the invention, the method includes the following steps. First, 3D environment information is acquired when a software application transmits the 3D environment information to a 3D graphics engine. The 3D environment information is for the 3D graphics engine to generate a 3D main image. Then, an assist image is generated according to the acquired 3D environment information.

Users can have more basis to determine what to do according to the assist image generated by the preferred embodiments of the invention. Moreover, the acquiring and generating steps access few system resources, effectively improving the poor information that the application user has when the software application is executing.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a traditional 3D image processing apparatus;

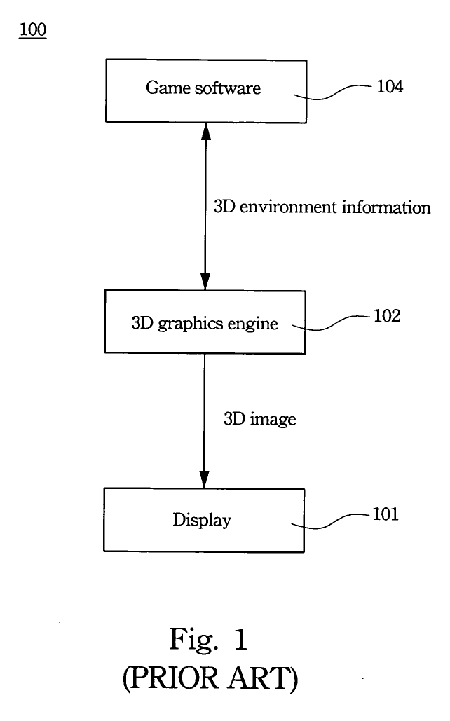

FIG. 2 is a schematic diagram of an apparatus for processing 3D images according to one preferred embodiment of this invention;

FIG. 3 is a flow chart of a method according to one preferred embodiment of this invention; and

FIG. 4 is a flow chart of a method according to another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to make sure that the user can watch the required 3D images in real time, parts or total 3D virtual world should be established in advance for 3D image of user's request is unpredictable in next step when processing the 3D images. The 3D virtual world is usually established by 3D environment information from a 3D graphics engine. Thus, the embodiment of the invention generates an assist image according to the 3D environment information for providing the user more information such that the user has more basis to determine what to do. The 3D environment information is acquired from a graphic state and parameters transmitted between a 3D graphic engine and the software application.

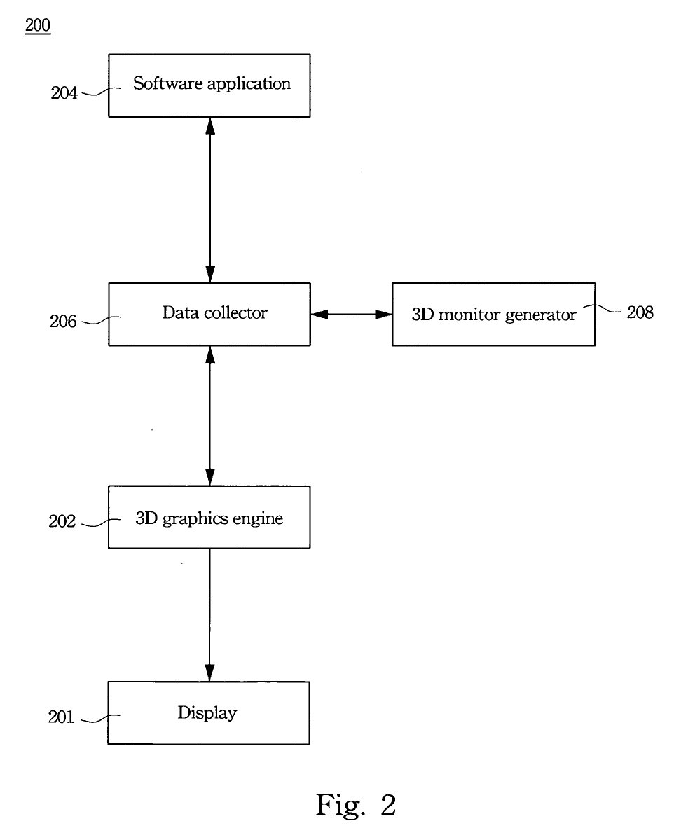

Reference is made to FIG. 2, which is a schematic diagram of an apparatus for processing 3D images according to one preferred embodiment of this invention. An apparatus for processing three-dimensional (3D) images 200 has a 3D graphics engine 202, a data collector 206 and a 3D monitor generator 208. The 3D graphics engine 202 receives 3D environment information from a software application 204, and generates a 3D main image according to the 3D environment information. The data collector 206 acquires the 3D environment information between the software application 204 and the 3D graphics engine 202. The 3D monitor generator 208 is connected to the data collector 206 and generates an assist image according to the acquired 3D environment information.

More specifically, the 3D graphics engine 202 transmits the 3D main image to a display 201 for displaying to the user. In this embodiment, the data collector 206 acquires the 3D environment information between the software application 204 and the 3D graphics engine 202, and the 3D monitor generator 208 sends a request to the data collector 206 for obtaining the 3D environment information to generate the assist image according to the acquired 3D environment information. The acquired 3D environment information may be full, partial, selected or processed 3D environment information.

Moreover, the 3D graphics engine 202 is arranged to overlap the assist image onto the 3D main image. The assist image may be a sub-image window displayed on the 3D main image such that the user can watch those two images in one display. Alternatively, the 3D main image and the assist image may be separately displayed on different displays such that the user can obtain more and concise information on those displays.

Furthermore, the 3D image processing apparatus 200 further includes a user interface arranged in, for example, the 3D monitor generator 208 to set a window quantity, an image angle, an image size, an image content or other parameter of the assist image. The user interface may also be arranged independently or in other software, hardware or operating system.

In addition, a graphic state or parameter is fed back to the software application 204 after the 3D graphic engine 202 generates the 3D main image. In another embodiment of the invention, the data collector 206 acquires the graphic state or parameter in addition to the 3D environment information. After receiving the request sent by the 3D monitor generator 208, the data collector 206 transmits the graphic state or parameter to the 3D monitor generator 208 for generating the assist image. The graphic state or parameter may be parts of or all of the graphic state or parameter.

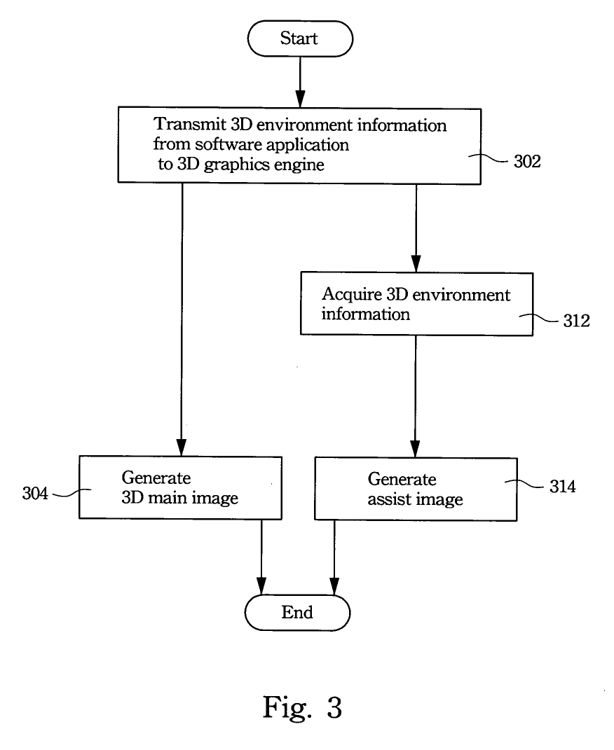

Reference is made to FIG. 3, which is a flow chart of a method according to one preferred embodiment of this invention. A processing method includes the following steps. The step 302 is transmitting a 3D environment information from a software application to a 3D graphics engine. The step 312 is acquiring the 3D environment information transmitted in the step 302. The step 304 is generating a 3D main image according to the 3D environment information. The step 314 is generating an assist image according to the acquired 3D environment information.

For example, the 3D environment information is transmitted from the software application (such as game software or other 3D image software application) to the 3D graphics engine for generating the 3D main image. In this embodiment of the invention, the 3D environment information transmitted from the software application to the 3D graphics engine is acquired for generating the assist image. The acquired 3D environment information may be full, partial, selected or processed 3D environment information.

The processing method may include providing a user interface arranged to set a window quantity, an image angle, an image size, an image content or other parameter of the assist image. Moreover, the 3D environment information is related to spatial coordinates. For example, the 3D environment information may include 3D-scene global data for establishing a 3D virtual world. However, the 3D virtual world may be established partially in particular situations.

Furthermore, a graphic state or parameter is fed back to the software application after the 3D main image is generated. Besides the 3D environment information, the graphic state or parameter is also acquired for generating the assist image in another embodiment of the invention. The graphic state or parameter may be parts of or all of the graphic state or parameter.

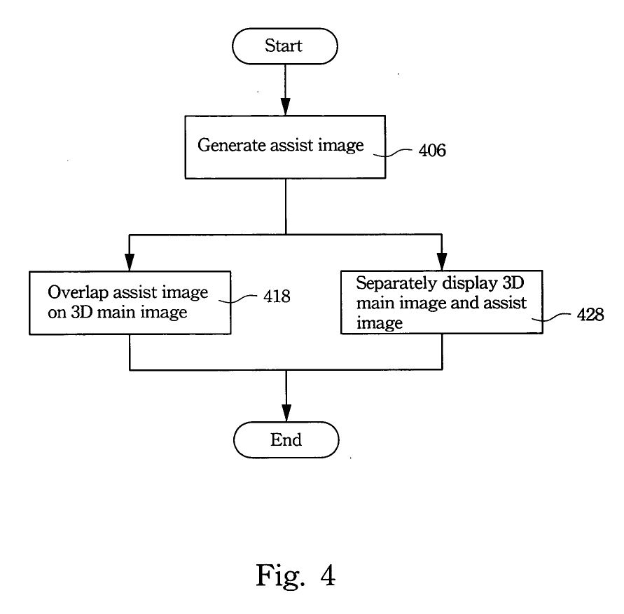

Reference is made to FIG. 4, which is a flow chart of a method according to another preferred embodiment of this invention. The difference between this embodiment and the embodiment illustrated in FIG. 3 is that this embodiment details the steps for displaying the assist image. The following statement only specifies the displaying steps; the other steps are incorporated by reference to those disclosed in the embodiment illustrated in FIG. 3.

In FIG. 4, the step 406 is generating an assist image. The step 418 is overlapping the assist image onto a 3D main image after the step 406. Alternatively, the step 428 may be performed, which is displaying the 3D main image and the assist image on different displays.

For example, the assist image may be a sub-image window displayed on the 3D main image such that the user can watch those two images in one display. Alternatively, the 3D main image and the assist image may be separately displayed on different displays such that the user can obtain more and concise information on those displays.

More specifically, the 3D environment information is related to spatial coordinates. In the embodiment of the invention, the 3D environment information may include 3D-scene global data for establishing a 3D virtual world that includes a plurality of 3D images for watching. However, in consideration of memory capacity, processor speed or display effect, the 3D environment information may only include a sufficient amount of 3D images as a user requests, and those images would be updated real-time according to the operating status of the user. In other words, the 3D virtual world may be established partially in a particular situation.

Moreover, the assist image may be a top view, a perspective view, a back view, a side view, a 3D image in any other visual angle, a 3D image with some parts hidden or covered, or a statistical graph that includes selected or processed data. The 3D graphics engine preferably is OpenGL™ or DirectX™ to adapt to current 3D graphics technology. However, other adaptable or novel assist images and 3D graphics engines may also be included in the embodiment of the invention.

As mentioned above, users can have more basis to determine what to do according to the assist image generated by the embodiments of the invention. Moreover, the acquiring and generating steps actually access few system resources, effectively improving the poor information that the application user has when the software application is being executing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for processing three-dimensional (3D) images, comprising:
a 3D graphics engine, arranged to receive 3D environment information from a software application and generate a 3D main image according to the 3D environment information;
a data collector connected between the software application and the 3D graphics engine to acquire the 3D environment information; and
a 3D monitor generator connected to the data collector and arranged to generate an assist image according to the acquired 3D environment information.

2. The apparatus for processing 3D images as claimed in claim 1, wherein the 3D graphics engine is further arranged to overlap the assist image onto the 3D main image.

3. The apparatus for processing 3D images as claimed in claim 1, wherein the 3D main image and the assist image are separately displayed on different displays.

4. The apparatus for processing 3D images as claimed in claim 1, further comprising a user interface arranged to set a window quantity, an image angle, an image size or an image content of the assist image.

5. The apparatus for processing 3D images as claimed in claim 1, wherein the 3D environment information comprises whole 3D virtual world data.

6. The apparatus for processing 3D images as claimed in claim 1, wherein the 3D environment information is related to spatial coordinates.

7. The apparatus for processing 3D images as claimed in claim 1, wherein the 3D graphics engine is arranged to transmit a graphic state or parameter to the software application; the data collector is arranged to acquire the graphic state or parameter; and the 3D monitor generator is arranged to generate the assist image according to the acquired 3D environment information and the acquired graphic state or parameter.

8. A method for processing three-dimensional (3D) images, comprising the steps of:
acquiring 3D environment information when a software application transmits the 3D environment information to a 3D graphics engine, wherein the 3D environment information is for the 3D graphics engine to generate a 3D main image; and
generating an assist image according to the acquired 3D environment information.

9. The method for processing 3D images as claimed in claim 8, further comprising overlapping the assist image onto the 3D main image.

10. The method for processing 3D images as claimed in claim 8, further comprising displaying the 3D main image and the assist image separately on different displays.

11. The method for processing 3D images as claimed in claim 8, further comprising providing a user interface arranged to set a window quantity, an image angle, an image size or an image content of the assist image.

12. The method for processing 3D images as claimed in claim 8, wherein the 3D environment information comprises 3D-scene global data.

13. The method for processing 3D images as claimed in claim 8, wherein the 3D environment information is related to spatial coordinates.

14. The method for processing 3D images as claimed in claim 8, further comprising:
acquiring a graphic state or parameter when the 3D graphics engine transmits the graphic state or parameter to the software application; and
generating the assist image according to the acquired 3D environment information and the acquired graphic state or parameter.
